(19) United States
(12) Patent Application Publication
(10) Pub. No.: US 2007/0211358 A1
(43) Pub. Date: Sep. 13, 2007

(54) Total reflection mirror

(75) Inventor: Kazutoshi Setoguchi, Miyazaki-shi (JP)

Correspondence Address: OLIFF & BERRIDGE, PLC, P.O. BOX 19928, ALEXANDRIA, VA, 22320, US

(73) Assignee: EPSON TOYOCOM CORPORATION, TOKYO (JP)

(21) Appl. No.: 11/712,476

(22) Filed: Mar. 1, 2007

(30) Foreign Application Priority Data
Mar. 10, 2006 (JP) 2006-065230

(51) Int. Cl. G02B 1/10; G02B 5/08

(52) U.S. Cl. 359/883; 359/838

(57) ABSTRACT

A total reflection mirror having a mirror coating formed on one main surface of a transparent substrate includes forming a correction coating with a reflection index approximately equal to that of the transparent substrate on second main surface of the transparent substrate and correcting warping of the transparent substrate due to a stress of the mirror coating, using a stress of the correction coating.

### BACKGROUND OF THE INVENTION

1. Technical Field

The present invention relates to a total reflection mirror used for an optical pickup of an optical disc recorder/reproducer, and is especially suited to prevent deterioration of an optical property or the like, such as wavefront aberration.

2. Related Art

A total reflection mirror for reflecting incident light, or the like is widely used for an optical pickup of an optical disc recorder/reproducer or the like such as a CD in the 780 nm range, a DVD in the 660 nm range, or a blue-laser disc (hereinafter, referred to as a BD) represented by a Blu-ray Disc or an HD DVD using a blue-violet laser in the 405 nm range.

Various types of optical coatings are formed on, for example, a glass substrate in the making of the total reflection mirror as described above.

A first example of related art discloses an optical multilayer coating filter which prevents optical distortion by further decreasing a warping width of a substrate due to a stress of a dielectric thin-coating laminated on a transparent substrate.

A second example of related art discloses an optical multilayer coating filter which can reduce stress or warping of a coating to a greater extent than the existing optical multilayer coating, even where the number of the dielectric multilayer coating is set to 40 or more.

JA-A-2005-43755 is the first example of related art and JA-A-7-209516 is the second example of related art.

However, where an optical coating 52 as a thin-coating such as a mirror coating (hereinafter refereed to as an MR coating) is formed on one main surface 51a of the glass substrate 51 as shown in FIG. 2A, a stress is produced at a side of the main surface 51a of the glass substrate 51 because of effects from difference in a thermal expansion coefficient between the glass substrate 51 and the optical coating 52. At this time, where the stress produced as a side of the main surface 51a of the glass substrate is a tensile stress recessed warping occurs at a side of the main surface 51a of the glass substrate 51 as shown in FIG. 2B. On the other hand, where the stress produced at a side of the main surface 51a of the glass substrate 51 is a compressive stress, projecting warping occurs at a side of the main surface 51b of the glass substrate as 51 shown in FIG. 2C. As the result, there have been such problems that wavefront aberration of an optical component deteriorates and that the desired optical property is not satisfied.

For an optical element used for an optical pickup provided for two-wavelength, i.e., CD and DVD, and further, for an optical pickup provided for three-wavelength, i.e., CD, DVD, and BD, more advanced optical specifications have been required in recent years.

The total reflection mirror with a structure as shown in FIG. 2 cannot be adapted for the optical pickup under the standard which is strict especially for the wavefront aberration.

### SUMMARY

An advantage of the invention is to provide a total reflection mirror satisfying a desired optical property without deterioration of wavefront aberration.

According to an aspect of the invention, a total reflection mirror having a mirror coating formed on one main surface of a transparent substrate includes forming a correction coating with a reflection index approximately equal to that of the transparent substrate on second main surface of the transparent substrate, and correcting warping of the transparent substrate due to a stress of the mirror coating, using a stress of the correction coating. With the structure in this manner, a stress of the correction coating formed on the second main surface of the transparent substrate enables a balance between stresses of the mirror coating formed on the one main surface of the transparent substrate and the correction coating formed on the second main surface. Thus, warping of the transparent substrate can be corrected, thereby being able to realize the total reflection mirror satisfying the desired optical property without deterioration of the wavefront aberration.

In this case, where the transparent substrate composing the total reflection mirror is made of a white plate glass while the correction coating is made of an SiO₂ coating, the transparent substrate and the correction coating can be set approximately the same in a reflection index, thereby being able to minimize deterioration of the optical property due to difference in a reflection index between the transparent substrate and the correction coating.

### BRIEF DESCRIPTION OF THE DRAWINGS

The invention will be described with reference to the accompanying drawings, wherein like numbers reference like elements.

FIG. 1 is a cross-sectional view showing a structure of a total reflection mirror according to an embodiment of the invention.

FIG. 2 is a cross-sectional view showing a structure of an existing total reflection mirror.

### DESCRIPTION OF EXEMPLARY EMBODIMENTS

Hereinafter, an embodiment of the invention will be explained with reference to drawings.

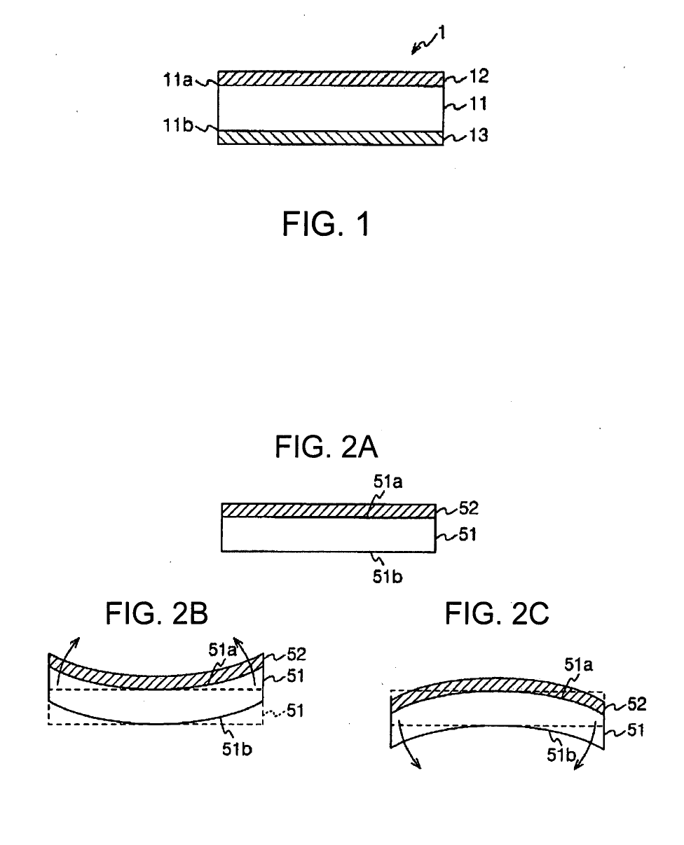

FIG. 1 is a cross-sectional view showing a structure of a total reflection mirror according to the embodiment of the invention.

A total reflection mirror 1 according to the invention, shown in FIG. 1, is characterized in that an MR coating 12 as a mirror coating is formed on one main surface 11a of a transparent substrate 11 while a correction coating 13 is formed on the other main surface 11b of the transparent substrate 11 so that a stress of the correction coating 13 compensates for a stress of the MR coating 12 formed on the main surface 11a of the transparent 11 to achieve a balance between those stresses so the transparent substrate 11 as to be prevented from occurrence of warping.

Furthermore, the correction amount can be arbitrarily adjusted by changing a coating thickness of the correction coating 13 since warping δ of the substrate can be expressed by a relational expression with respect to a coating thickness D, such as shown by the following expression (1).

σ=Es×B̂2×δ/3(1−vs)×D×L̂2 (1)

σ: a coating stress, Es: Young's modules of a substrate, B: a substrate thickness, δ: the displacement amount (warping amount) of a front end of a substrate, vs: Poisson's ratio of a substrate, L: a substrate length, D: a coating thickness

Herein, where the stress of the MR coating 12 formed on the main surface 11a of the transparent substrate 11 is a compressive stress, the correction coating 13 with a compressive stress is formed on the other main surface 11b of the transparent substrate 11 so that those stresses of both main surfaces 11a, 11b of the transparent substrate 11 compensate for each other to achieve a balance therebetween.

The correction coating 13 in this case is made of a coating material with a reflective index approximately equal to that of the transparent substrate 11 not to hinder the optical property of the transparent substrate 11.

For example, where a white plate glass with a reflective index of 1.52 is used as the transparent substrate 11, the correction coating 13 is made of an SiO₂ coating with a reflection index of 1.46, which is close in a reflection index to the white plate glass.

Additionally, other than the white glass, an SiO₂ substrate with a reflection index of 1.46, a BK7 (Borosilicate crown glass) with a reflection index of 1.51, or the like can be used as the transparent substrate 11.

Furthermore, where the MR coating 12 has a tensile stress, not a compressive stress, a coating material with a tensile stress, for example, an Al₂O₃ coating with a reflective index of 1.62, an MgF₂ coating with a reflective index of 1.38, or the like can be used as the correction coating 13.

As described above, in this embodiment, on the total reflection mirror 1 in which the MR coating 12 is formed on the main surface 11a of the transparent substrate 11, the correction coating 13 with a reflection index approximately equal to that of the transparent substrate 11 is formed on the main surface 11b of the transparent substrate 11 so that warping of the transparent substrate 11 due to a stress of the MR coating 12 is corrected with a stress of the correction coating 13. With a structure as described above, a stress of the correction coating 13 formed on the main surface 11b of the transparent substrate 11 enables correction of warping of the transparent substrate 11 by achieving a balance between stresses of the MR coating 12 formed on the main surface 11a of the transparent substrate 11 and the correction coating 13 formed on the main surface 11b, thereby being able to realize the total reflection mirror satisfying the optical property of the optical pickup under a strict wavefront-aberration standard, which uses blue laser light.

Where the transparent substrate 11 composing the total reflection mirror 1 is made of a white plate glass while the correction coating 13 is made of an SiO₂ coating, likewise this embodiment, the transparent substrate 11 and the correction coating 13 can be set approximately the same in a reflection index, resulting in an advantage of minimizing deterioration of the optical property due to difference in a reflection index between the transparent substrate 11 and the correction coating 13.

What is claimed is:

1. A total reflection mirror having a mirror coating formed on one main surface of a transparent substrate, comprising:
forming a correction coating with a reflection index approximately equal to that of the transparent substrate on second main surface of the transparent substrate; and
correcting warping of the transparent substrate due to a stress of the mirror coating, using a stress of the correction coating.

2. The total reflection mirror according to claim 1, wherein the transparent substrate is defined as a white plate glass and the correction coating is defined as an SiO₂ coating.
